(19) United States
(12) Patent Application Publication
(10) Pub. No.: US 2020/0098042 A1
(43) Pub. Date: Mar. 26, 2020

(54) Trading Apparatus, And Trading Method

(71) Applicant: Axell Corporation, Tokyo (JP)

(72) Inventor: Yusuke HOSHIZUKI, Tokyo (JP)

(73) Assignee: Axell Corporation, Tokyo (JP)

(21) Appl. No.: 16/559,536

(22) Filed: Sep. 3, 2019

(30) Foreign Application Priority Data
Sep. 21, 2018 (JP) 2018-177386

(51) Int. Cl. G06Q 40/04; G06Q 20/38; H04L 9/06

(52) U.S. Cl. CPC G06Q 40/04; H04L 9/0637; G06Q 20/3829; G06Q 20/3825

(57) ABSTRACT

A trading apparatus includes a storage unit and a processor. The processor generates a first electronic signature to be included in second trading information that is used for a trade of delivering second data to a trading partner after first trading information to be used for a trade of delivering first data to the user is published on a first network. The processor generates a second electronic signature to be included in fourth trading information that is used for a trade of receiving the first data from the trading partner using information included in the first trading information. The processor stores the second electronic signature in the storage unit. The processor creates the fourth trading information using the second electronic signature stored in the storage unit after third trading information that is used for a trade of receiving the second data from the user is published on a second network.

### RELATED APPLICATIONS

This application claims priority to Japanese Patent Application No. JP2018-177386, filed Sep. 21, 2018, entitled Trading Apparatus, And Trading Method, which is hereby incorporated herein by reference in its entirety.

### FIELD

The embodiments discussed herein are related to a trading apparatus, and a trading method.

### BACKGROUND

Cryptocurrencies (virtual currencies) having trading information recorded on respective blockchains are used. A blockchain is a database in which blocks each including plural pieces of trading information are generated and the generated blocks are linked to record data in a distributed network. Since a block includes a hash value indicating the contents of a block generated immediately before as well as plural pieces of trading information, the blockchain has a data structure in which generated blocks are connected in chronological order.

There are plural types of cryptocurrencies having different characteristics. Accordingly, when cryptocurrencies are to be used, a user selects one of the cryptocurrencies to use a cryptocurrencies suitable for his application. The types of cryptocurrencies include, for example, Bitcoin (BTC: registered trademark), Ethereum (ETH: registered trademark), Litecoin (LTC: registered trademark), and Monacoin (MONA: registered trademark). Applications of cryptocurrencies are, for example, value conservation, merchandise purchase, and fees for management of contract details.

In order to use plural types of cryptocurrencies according to applications as described above, trades for exchanging different cryptocurrencies are performed. Trades for exchanging different cryptocurrencies include a direct trade which is a trade performed directly between a user and a user as the trading partner, and an intermediary trade which is a trade performed between a user and a user as the trading partner via a third party such as an exchange. In the following explanations, a user as a trading partner is also referred to simply as “trading partner”.

The direct trade of cryptocurrencies is explained. For example, when performing an exchange trade between Bitcoins owned by a user himself and Litecoins owned by a trading partner, the user sends the Bitcoins to the trading partner. Upon confirming that the Bitcoins have reached from the user, the trading partner sends the Litecoins.

In the direct trade, the trading partner can abscond the Bitcoins without sending the Litecoins to the user after having confirmed that the Bitcoins have reached from the user. Therefore, the user needs to send the Bitcoins to the trading partner on the presumption that the trading partner is a credible person.

The intermediary trade of cryptocurrencies is explained. For example, a user entrusts Bitcoins owned by the user himself to an exchange. The trading partner entrusts Litecoins owned by the trading partner himself to the exchange. The exchange then sends the Litecoins entrusted by the trading partner to the user and sends the Bitcoins entrusted by the user to the trading partner.

Since the user and the trading partner entrust cryptocurrencies to an exchange in the intermediary trade, there is a risk that the cryptocurrencies are stolen through a fraudulence of the exchange, hacking into the exchange, or the like. Further, because an exchange is used, fees are sometimes relatively higher in the intermediary trade than in the direct trade. Therefore, the user needs to entrust Bitcoins on the presumption that the exchange is credible and that the fees are relatively high.

In order to solve the problems described above, there has been used a trading system called an Atomic Swap, which enables a direct trade without absconding of cryptocurrencies even in a trade between individuals without credibility.

There is a related technique that enables composite trade forms to be dealt in one transaction while ensuring the reliability of trade details described in the transaction. In the related technique, asset transfer sources (retaining sources) “a” and “b” permit trading information related to composite trades to be described in one transaction (a composite transaction) on condition that signatures “a” and “b” according to private keys of addresses managed by themselves are added, respectively. In the case of recording the composite transaction in a database, one condition of the recording is that all the signatures “a” and “b” of the asset transfer sources are valid to prevent an identity thief (including parties as the subjects of the trade) (for example, see International Publication No. 2017/170912 and bitcoin wiki, [retrieved on Mar. 1, 2018], network, URL:https://en.bitcoin.it/wiki/Atomic_cross-chain_trading).

In an atomic swap, each user transmits trading information to a network of a blockchain twice at an interval equal to or longer than an approval time of the blockchain. In the case of using a hardware wallet, a user brings the hardware wallet in an offline state by disconnecting the hardware wallet from a trading apparatus during a period other than a process of generating an electronic signature to prevent a theft of the private key. Accordingly, in an atomic swap using a hardware wallet, the hardware wallet is inserted into or removed from the trading apparatus and therefore the operation of the user becomes complicated.

### SUMMARY

A trading apparatus disclosed in the present specification includes a storage unit and a processor. The processor executes a process of generating a first electronic signature to be included in second trading information including specific information calculated using secret information, after first trading information including the specific information is published on a first network. The processor also executes a process of generating a second electronic signature to be included in fourth trading information using information included in the first trading information. The processor stores the second electronic signature in the storage unit. The processor further executes a process of creating the second trading information including the specific information and the first electronic signature. The processor also executes a process of creating the fourth trading information including the secret information and the second electronic signature using the second electronic signature stored in the storage unit after third trading information including the secret information is published on a second network. The processor then executes a process of transmitting the fourth trading information to the first network and a process of transmitting the second trading information to the second network. The first trading information is information used for a trade in which first data is delivered from a trading partner to a user. The second trading information is information used for a trade in which second data is delivered from the user to the trading partner. The third trading information is information used for a trade in which the trading partner receives the second data from the user. The fourth trading information is information used for a trade in which the user receives the first data from the trading partner.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network structure used for an atomic swap.

FIG. 2A and FIG. 2B are diagrams illustrating an example of trading information of cryptocurrencies.

FIG. 3A, FIG. 3B, FIG. 3C, and FIG. 3D are diagrams illustrating an example of processing of an atomic swap.

FIG. 4 is a sequence diagram illustrating an example of processing of an atomic swap using a hardware wallet.

FIG. 5 is a sequence diagram illustrating an example of processing of an atomic swap using a hardware wallet according to an embodiment.

FIG. 6 is a functional block diagram illustrating a practical example of a trading apparatus.

FIG. 7 is a block diagram illustrating a practical example of a computer device.

### DESCRIPTION OF EMBODIMENTS

A trading apparatus according to an embodiment is explained below. In the following explanations, processing in which a trading apparatus exchanges different types of cryptocurrencies using an atomic swap is described. The atomic swap performed by the trading apparatus according to the embodiment can be also used for the exchange of data used in transmission of messages, management of contract details, and the like, as well as for the exchange of cryptocurrencies.

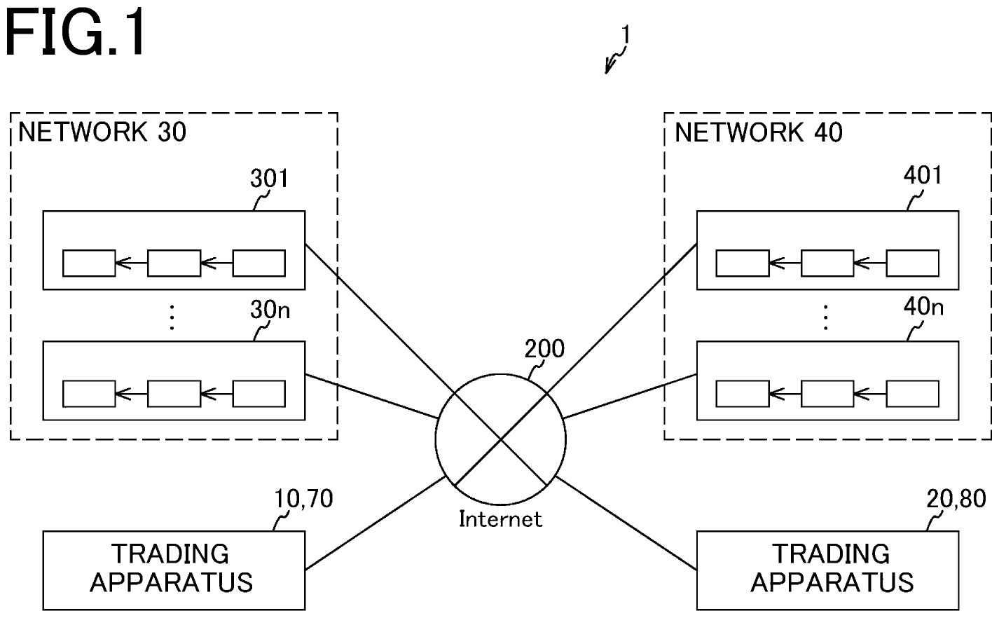

FIG. 1 is a diagram illustrating an example of a network structure used for an atomic swap. The network structure used for the atomic swap is explained with reference to FIG. 1. A network used for the atomic swap includes a trading apparatus 10, a trading apparatus 20, a network 30, a network 40, and a network 200. The trading apparatus 10, the trading apparatus 20, the network 30, and the network 40 are connected to be communicable with each other via the network 200.

The trading apparatus 10 and the trading apparatus 20 are, for example, computer devices which will be described later. In the following explanations, it is assumed as an example that the trading apparatus 10 is a trading apparatus operated by a trading partner. It is also assumed that the trading apparatus 20 is a trading apparatus operated by a user.

The network 30 and the network 40 are distributed networks such as a P2P (peer-to-peer) network, and record trading information on blockchains. In the following explanations, as an example, the network 30 is assumed to employ proof-of-work (PoW) that is a consensus algorithm in Bitcoin. The network 40 is assumed to employ proof-of-work that is a consensus algorithm in Litecoin.

A blockchain on which trades occurring in the network 30 are recorded is also referred to as “Bitcoin blockchain”. A blockchain on which trades occurring in the network 40 are recorded is also referred to as “Litecoin blockchain”. Each of the network 30 and the network 40 may employ other consensus algorithms such as proof-of-stake (PoS), proof-of-importance (PoI), and proof-of-consensus (PoC).

In the network 30, a plurality of node devices 301 to 30n that perform mining are connected to one another communicably. In the network 40, a plurality of node devices 401 to 40n that perform mining are connected to one another communicably. In the following explanations, the node devices 301 to 30n are also referred to as “node devices 300” when these node devices are not particularly distinguished from each other. The node devices 401 to 40n are also referred to as “node devices 400” when these node devices are not particularly distinguished from each other.

In the proof-of-work, mining is an operation of searching for a nonce (hereinafter, also “correct nonce”) that enables to obtain a hash value including a predetermined number of consecutive zeros (0) or more when a hash function is applied to data of a block while the nonce included in the block is changed. Data of a block includes the hash value of data of a previous block linked to the block, the nonce, and trading information.

When a block is to be generated, the node device verifies a transaction to be included in the block. The node device then approves a correct transaction, causes the approved transaction to be included in the block, and performs an operation of searching for the nonce, \Mien a correct nonce is found, the node device generates a block including the correct nonce, and links the newly-generated block to the blockchain retained in the node device. The node device transmits the newly-generated block onto a network of the blockchain. The newly-generated block is linked also to blockchains retained in other node devices connected to the network. In this way, the transaction is recorded on the blockchains. In the following explanations, linking a block including a transaction to a blockchain is also referred to as “recording a transaction on a blockchain”.

The network 200 may be further connected to other networks as well as the network 30 and the network 40. The network 200 may be further connected to other trading apparatuses in addition to the trading apparatus 10 and the trading apparatus 20.

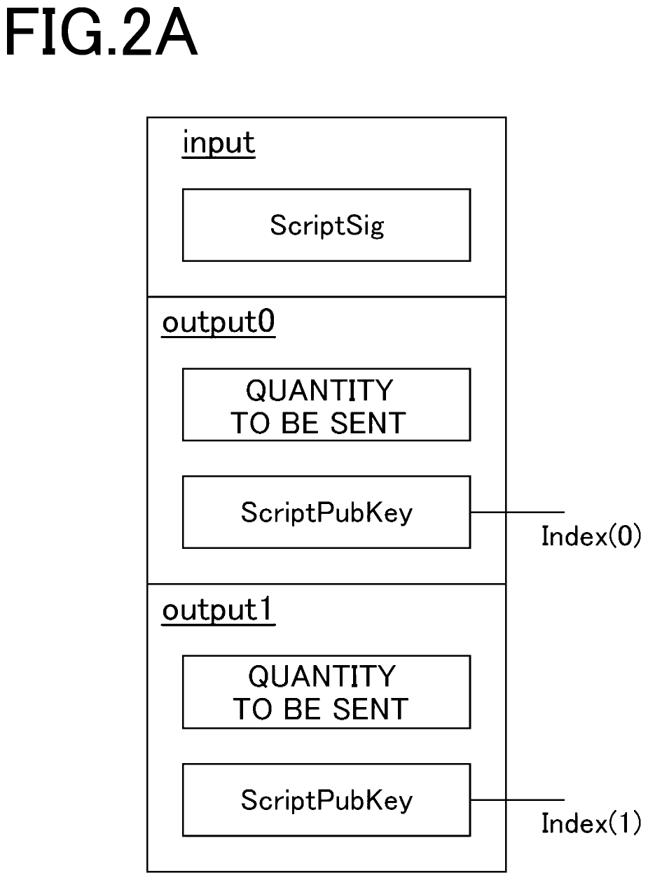

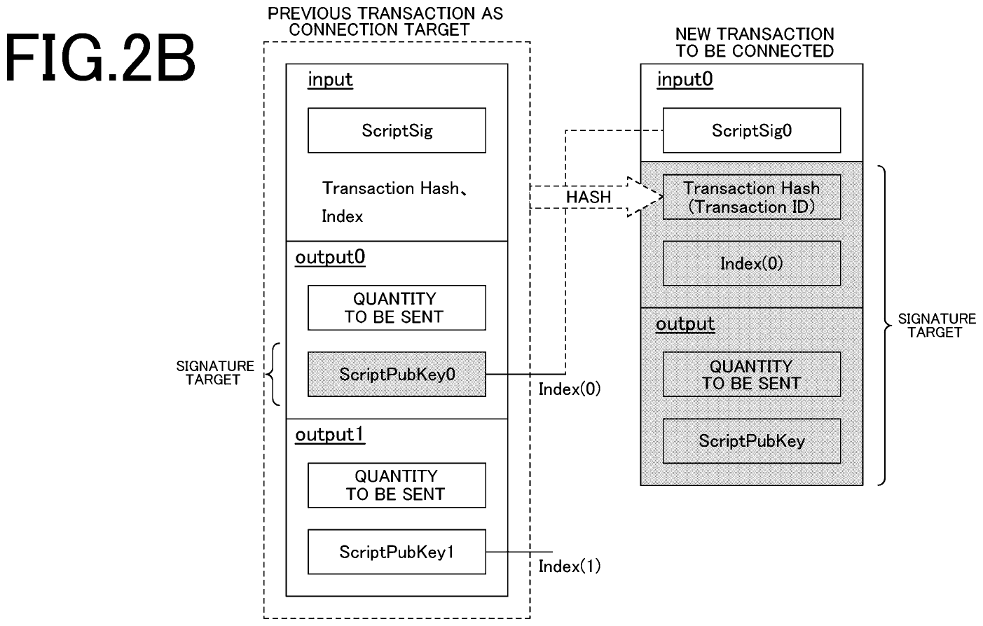

FIGS. 2A and 2B are diagrams illustrating an example of trading information of cryptocurrencies. FIG. 2A is a diagram explaining a configuration of trading information. FIG. 2B is a diagram explaining a process of connecting trading information. Trading information is a transaction to be used for a process of performing delivery and reception of a cryptocurrency to transfer ownership of the cryptocurrency.

In the following explanations, it is assumed that P2PKH (Pay to Public Key Hash) is used as a transaction script. In the case of using P2PK (Pay to Public Key) as a transaction script, ScriptPubKey locking a UTXO includes a public key of a user being a transmission destination which is a receiver of the UTXO. In the P2PK, ScriptSig unlocking a UTXO includes an electronic signature generated using a private key of a user being a transmission source which creates a transaction as a provider of the UTXO.

A UTXO is an unspent output of a transaction, which has not been spent as an input in a transaction. A UTXO is ownership of a cryptocurrency and a UTXO is spent as an input in the next transaction. Therefore, sending of a cryptocurrency is that a UTXO is spent by a sender and a UTXO that can be spent only by a receiver is created. An input in a transaction is information for processing a use of a cryptocurrency. An output in a transaction is information for processing an application of a cryptocurrency. UTXO stands for Unspent Transaction Output.

An electronic signature is, for example, a value obtained by encrypting an electronic signature value obtained using data of a transaction except ScriptSig and ScriptPubKey of a previous transaction, with a private key of a user being a transmission source that creates a transaction. The previous transaction is a transaction that is connected to an input of a transaction created at the time of sending by the user being the transmission source and that includes an output describing information of sending to the user being the transmission source. The electronic signature value is, for example, a value obtained by applying a hash function to data including the data of the transaction except ScriptSig and ScriptPubKey of the previous transaction.

A configuration of a transaction is explained with reference to FIG. 2A. A transaction is trading information outlining transfers of cryptocurrency ownership. A transaction includes an input and an output.

The input is information for unlocking a UTXO of the previous transaction owned by a user being a transmission source that creates a transaction. The input includes ScriptSig.

ScriptSig is a script for unlocking a UTXO owned by the user being the transmission source. ScriptSig includes an electronic signature and a public key of the user as the transmission source. The electronic signature and the public key included in ScriptSig are values generated using a private kay of the user as the transmission source.

The output is information indicating a transfer of cryptocurrency ownership. The output includes a quantity to be sent and ScriptPubKey.

ScriptPubKey is a script that defines a condition for unlocking an output of the transaction. ScriptPubKey includes a hash value (hereinafter, also “public key hash”) of a public key generated using a private key of a user as a transmission destination.

A process of connecting transactions is explained with reference to FIG. 2B. In the following explanations, as an example, a process in which an output 0 of a previous transaction as a connection target is connected to a new transaction is described. It is assumed that the transactions are processed in the network 30.

The output of the previous transaction includes the output 0 including a quantity to be sent and ScriptPubKey0, and an output 1 including a quantity to be sent and ScriptPubKey1. The output 0 and the output 1 are associated with Index0 and Index1, respectively. Index0 and Index1are identifierso identifying the output 0 and the output 1, respectively.

The input 0 of the new transaction is connected to the output 0 of the previous transaction. Since the input of the new transaction or other transactions is not connected to the output 1 of the previous transaction, the output 1 of the previous transaction is in the state of a UTXO.

The input 0 of the new transaction includes ScriptSig0, a transaction hash of the previous transaction, and Index0 being the identifier of the output 0 of the previous transaction.

ScriptSig0 includes an electronic signature and a public key to be used for a process of unlocking the output 0 of the previous transaction. The electronic signature is generated, for example, by encrypting an electronic signature value obtained using data of the new transaction except ScriptSig0 and ScriptPubKey0 included in the output 0 of the previous transaction, with a private key. At this time, a private key of the user creating the new transaction is used as the private key.

The transaction hash is a hash value of the whole previous transaction. The transaction hash is used as the transaction ID for identifying the previous transaction. Index0 is the identifier for identifying the output 0 as a connection destination in the previous transaction.

A process in which the output 0 included in the previous transaction and the input 0 included in the new transaction described above are connected is explained. In the following explanations, it is assumed that the previous transaction is in a state recorded on a Bitcoin blockchain.

The trading apparatus 10 creates the new transaction and transmits the new transaction to the network 30, thereby storing the new transaction in a transaction pool that is included in each of the node devices 300 to store therein unverified transactions. Upon selection of the new transaction as a verification target, the node device 300 refers to the transaction ID and Index0 of the new transaction and searches for a transaction on the blockchain. The node device 300 finds the previous transaction corresponding to the transaction ID and further finds the output 0 corresponding to Index0.

The node device 300 links ScriptSig0 included in the input 0 and ScriptPubKey0 included in the output 0 to each other. Accordingly, the node device 300 performs a first verification to verify matching between the hash value of the public key included in ScriptSig0 and the public key hash included in ScriptPubKey0. The node device 300 further performs a second verification to verify an electronic signature using the electronic signature and the public key included in ScriptSig0. When the first verification and the second verification are approved, the node device 300 connects the output 0 of the previous transaction and the input 0 of the new transaction to each other.

The node device 300 causes the approved new transaction to be included in a block and performs an operation of searching for a nonce. When a correct nonce is found, the node device 300 generates a block including the correct nonce and links the newly-generated block to the blockchain retained in the node device 300. The node device 300 further transmits the newly-generated block onto the network of the blockchain. Accordingly, the newly-generated block is also linked to the blockchains retained in other node devices connected to the network and the new transaction is recorded on the blockchains.

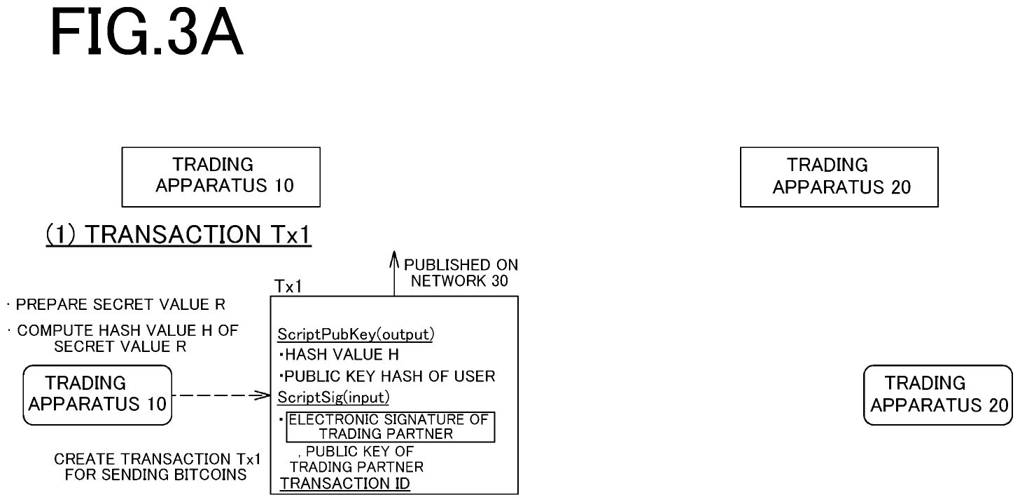

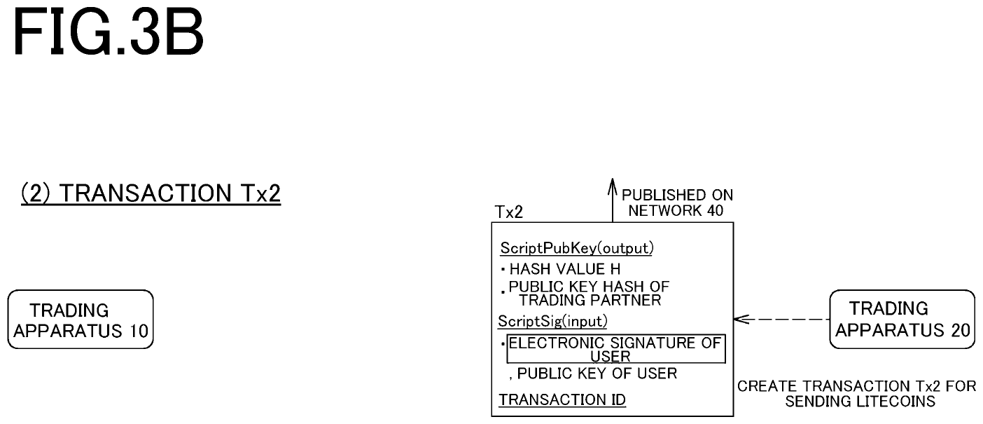

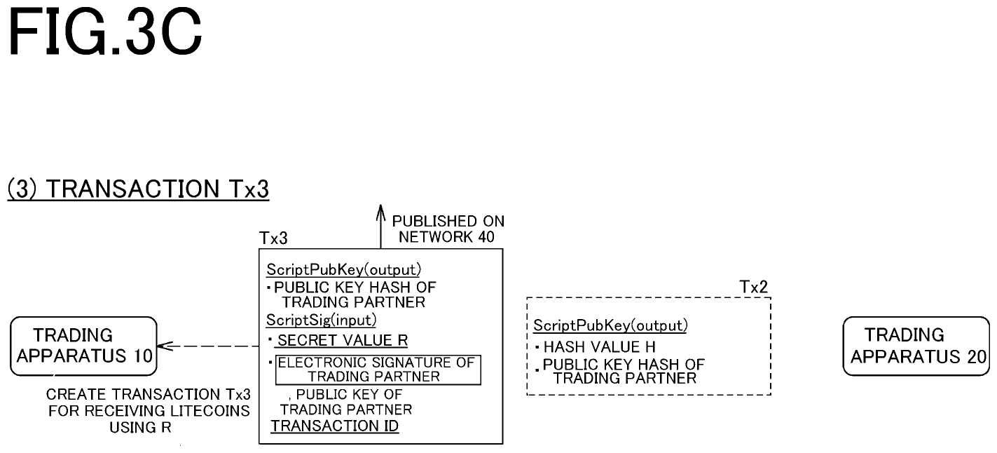

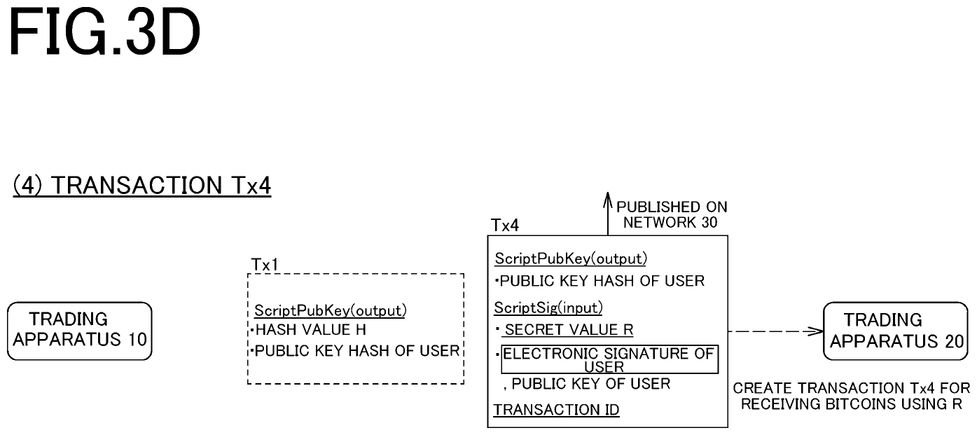

FIGS. 3A to 3D are diagrams illustrating an example of processing of an atomic swap. The processing of an atomic swap is explained with reference to FIGS. 3A to 3D. In the following explanations, as an example, a process of exchanging Bitcoins owned by a trading partner for Litecoins owned by a user is explained. While a process in which the trading apparatus 10 generates a secret value R is explained, the trading apparatus 20 may generate a secret value R. That is, processes performed by the trading apparatus 10 described below may be performed by the trading apparatus 20, and processes performed by the trading apparatus 20 may be performed by the trading apparatus 10. In order to simplify explanations, it is assumed that one output is included in the output of each transaction and explanations of a process of referring to an output according to Index are omitted. The quantities (exchange quantities) of cryptocurrencies to be exchanged can be determined between the user and the trading partner before the atomic swap processing on the basis of an exchange rate or the like. The user and the trading partner may exchange their own addresses and public keys before the atomic swap processing. The user and the trading partner may perform the determination on the exchange quantity of cryptocurrencies and the exchange of the addresses and public keys by any communication method such as an e-mail or provision of a recording medium.

At Step (1) illustrated in FIG. 3A, the trading apparatus 10 of the trading partner randomly generates the secret value R. The trading apparatus 10 applies a hash function to the secret value R to generate a hash value H. The hash function used by the trading apparatus 10 to hash the secret value R is, for example, a one-way hash function such as SHA-2, MD5, or SHA-1.

The trading apparatus 10 creates a transaction Tx1 for sending Bitcoins to the user. The trading apparatus 10 transmits the created transaction Tx1 to the network 30. Accordingly, the transaction Tx1 is published on the network 30.

The input of the transaction Tx1 includes ScriptSig including an electronic signature of the trading partner and a public key of the trading partner, and the transaction ID of the previous transaction including a UTXO to be unlocked. The UTXO to be unlocked by ScriptSig of the transaction Tx1 is a UTXO owned by the trading partner. The electronic signature of the trading partner and the public key of the trading partner are generated using a private key owned by the trading partner.

The output of the transaction Tx1 includes ScriptPubKey including the hash value H and a public key hash of the user. The public key hash of the user is generated using a public key of the user. The public key hash of the user is a hash value obtained by applying a hash function to the public key of the user.

At Step (2) illustrated in FIG. 3B, the trading apparatus 20 of the user creates a transaction Tx2 for sending Litecoins to the trading partner. The trading apparatus 20 then transmits the created transaction Tx2 to the network 40. Accordingly, the transaction Tx2 is published on the network 40.

The input of the transaction Tx2 includes ScriptSig including an electronic signature of the user and the public key of the user, and the transaction ID of the previous transaction including a UTXO to be unlocked. The UTXO to be unlocked by ScriptSig of the transaction Tx2 is a UTXO owned by the user. The electronic signature of the user and the public key of the user are generated using a private key owned by the user.

The output of the transaction Tx2 includes ScriptPubKey including the hash value H and a public key hash of the trading partner. The public key hash of the trading partner is generated using the public key of the trading partner. The public key hash of the trading partner is a hash value obtained by applying a hash function to the public key of the trading partner. The hash value H is acquired by the trading apparatus 20 from the transaction Tx1 and is described in the output of the transaction Tx2 when the transaction Tx1 has been published on the network 30.

At Step (3) illustrated in FIG. 3C, the trading apparatus 10 creates a transaction Tx3 for receiving the Litecoins from the trading apparatus 20. The trading apparatus 10 transmits the created transaction Tx3 to the network 40. Accordingly, the transaction Tx3 is published on the network 40.

The input of the transaction Tx3 includes ScriptSig including the secret value R, the public key of the trading partner, and the electronic signature of the trading partner, and the transaction ID for identifying the transaction Tx2 including the UTXO to be unlocked.

The output of the transaction Tx3 includes ScriptPubKey including the public key hash of the trading partner.

A process of transferring ownership of Litecoins sent by the user to the trading partner is explained through a process of unlocking the UTXO of the transaction Tx2 using the transaction Tx3 and locking the unlocked UTXO to the address of the trading partner as an example. The address of the trading partner is, for example, a value obtained by converting the public key hash of the trading partner.

When the transaction Tx3 is transmitted to the network 40, the node device 400 refers to the UTXO (output) of the transaction Tx2 corresponding to the transaction ID included in the transaction Tx3. The node device 400 obtains a hash value by applying a hash function to the secret value R included in ScriptSig of the transaction Tx3. The node device 400 performs a first verification to determine whether the obtained hash value matches the hash value H included in ScriptPubKey of the transaction Tx2. The hash function used by the node device 400 to obtain the hash value of the secret value R is the same hash function as that used by the trading apparatus 10 to hash the secret value R.

The node device 400 obtains a hash value by applying a hash function to the public key of the trading partner included in ScriptSig of the transaction Tx3. The node device 400 performs a second verification to determine whether the obtained hash value matches the public key hash of the trading partner included in ScriptPubKey of the transaction Tx2. The node device 400 also performs a third verification to verify an electronic signature using the electronic signature of the trading partner and the public key thereof included in ScriptSig of the transaction Tx3.

When the first verification, the second verification, and the third verification described above have been successful, the node device 400 locks the UTXO of the transaction Tx2 to the address of the trading partner. That is, the node device 400 creates an output indicating that the trading partner has received Litecoins and locks the created output as a UTXO owned by the trading partner and included in the transaction Tx3. Accordingly, ownership of the Litecoins is transferred from the user to the trading partner.

ScriptPubKey of the transaction Tx1 includes a script for performing a process of returning Bitcoins to the trading partner using the public key of the trading partner when the output of the transaction Tx1 remains as the UTXO after a predetermined time has passed. This enables the trading apparatus 10 to return the Bitcoins to the address of the trading partner after a lapse of the predetermined time if the trade is not completed. In the following explanations, the script for performing the process of returning a cryptocurrency is also referred to as “timelock”.

At Step (4) illustrated in FIG. 3D, the trading apparatus 20 acquires the secret value R included in the transaction Tx3 that is published on the network 40 by the trading partner, and creates a transaction Tx4 for receiving Bitcoins from the trading apparatus 10. The trading apparatus 20 transmits the created transaction Tx4 to the network 30. Accordingly, the transaction Tx4 is published on the network 30.

The input of the transaction Tx4 includes ScriptSig including the secret value R, the public key of the user, and the electronic signature of the user, and the transaction ID for identifying the transaction Tx1 including the UTXO to be unlocked.

The output of the transaction Tx4 includes ScriptPubKey including the public key hash of the user.

A process of transferring ownership of Bitcoins sent by the trading partner to the user is explained through a process of unlocking the UTXO of the transaction Tx1 using the transaction Tx4 and locking the unlocked UTXO to the address of the user as an example. The address of the user is, for example, a value obtained by converting the public key hash of the user.

When the transaction Tx4 is transmitted to the network 30, the node device 300 refers to the UTXO (output) of the transaction Tx1 corresponding to the transaction ID included in the transaction Tx4. The node device 300 obtains a hash value by applying a hash function to the secret value R included in ScriptSig of the transaction Tx4. The node device 300 performs a fourth verification to determine whether the obtained hash value matches the hash value H included in ScriptPubKey of the transaction Tx1. The hash function used by the node device 300 to obtain the hash value of the secret value R is the same hash function as that used by the trading apparatus 10 to hash the secret value R.

The node device 300 obtains a hash value by applying a hash function to the public key of the user included in ScriptSig of the transaction Tx4. The node device 300 performs a fifth verification to determine whether the obtained hash value matches the public key hash of the user included in ScriptPubKey of the transaction Tx1. The node device 300 further performs a sixth verification to verify of an electronic signature using the electronic signature of the user and the public key thereof included in ScriptSig of the transaction Tx4.

When the fourth verification, the fifth verification, and the sixth verification described above have been successful, the node device 300 locks the UTXO of the transaction Tx1 to the address of the user. That is, the node device 300 creates an output indicating that the user has received Bitcoins and locks the created output as a UTXO owned by the user and included in the transaction Tx4. Accordingly, ownership of the Bitcoins is transferred from the trading partner to the user.

ScriptPubKey of the transaction Tx2 includes a script for performing a process of returning Litecoins to the user using the public key of the user when the output of the transaction Tx2 remains as the UTXO after a predetermined time has passed. This enables the trading apparatus 20 to return the Litecoins to the address of the user after a lapse of the predetermined time when the trade is not completed.

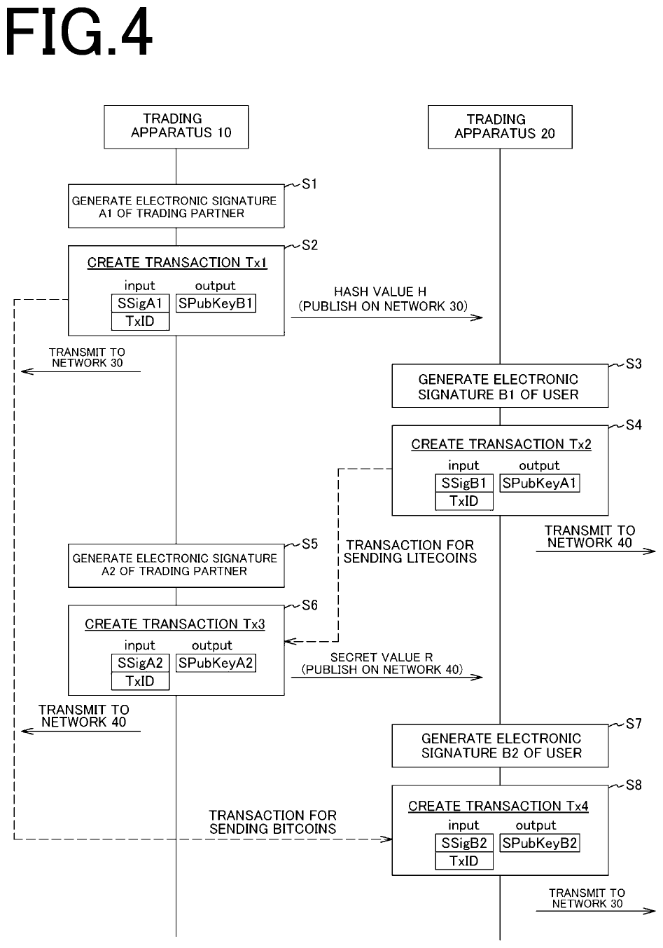

FIG. 4 is a diagram illustrating an example of the processing of an atomic swap using a hardware wallet. An atomic swap using a hardware wallet is explained with reference to FIG. 4. Explanations of the processes explained with reference to FIG. 3 are omitted. In the following explanations, it is assumed that a hardware wallet A has stored therein a secret key “a” of the trading partner. It is also assumed that a hardware wallet B has stored therein a secret key b of the user. Processes performed by the trading apparatus 10 described below may be performed by the trading apparatus 20, and processes performed by the trading apparatus 20 may be performed by the trading apparatus 10.

When the hardware wallet A is connected by the trading partner, the trading apparatus 10 generates an electronic signature A1 of the trading partner. Upon generation of the electronic signature A1 using the secret key “a”, the trading partner disconnects the hardware wallet A from the trading apparatus 10 (S1). The hardware wallet A can include, for example, a signature generation circuit that generates the electronic signature A1 using the stored secret key “a” when an electronic signature value is input from the trading apparatus 10.

The trading apparatus 10 creates a transaction Tx1 for sending Bitcoins to the user. The trading apparatus 10 then sends the transaction Tx1 to the network 30 (S2), Accordingly, the transaction Tx1 is published on the network 30,

The input of the transaction Tx1 includes ScriptSigA1 (SSigA1) including the electronic signature A1 and the public key of the trading partner, and the transaction ID of a previous transaction including a UTXO to be unlocked using ScriptSigA1. The output of the transaction Tx1 includes ScriptPubKeyB1 (SPubKeyB1) including the hash value H of the secret value R randomly generated by the trading apparatus 10 and the public key hash of the user. Therefore, the hash value H is published on the network 30 through transmission of the transaction Tx1 to the network 30 at S2.

When the hardware wallet B is connected by the user, the trading apparatus 20 generates an electronic signature B1 of the user. Upon generation of the electronic signature B1 using the secret key b, the user disconnects the hardware wallet B from the trading apparatus 20 (S3). The hardware wallet B can include, for example, a signature generation circuit that generates the electronic signature B1 using the stored secret key b when an electronic signature value is input from the trading apparatus 20, At S3, for example, the user connects the hardware wallet B to the trading apparatus 20 after the transaction Tx1 is recorded on a Bitcoin blockchain and a completion of sending is presumed.

The trading apparatus 20 creates a transaction Tx2 for sending Litecoins to the trading partner. The trading apparatus 20 transmits the transaction Tx2 to the network 40 (S4), Accordingly, the transaction Tx2 is published on the network 40,

The input of the transaction Tx2 includes ScriptSigB1 (SSigB1) including the electronic signature B1 and the public key of the user, and the transaction ID of a previous transaction including a UTXO to be unlocked using ScriptSigB1. The output of the transaction Tx2 includes ScriptPubKeyA1 (SPubKeyA1) including the hash value H published on the network 30 at S2 and the public key hash of the trading partner.

After the transaction Tx1 and the transaction Tx2 are approved and are recorded in blocks of the corresponding blockchains, respectively, the trading partner connects the hardware wallet A to the trading apparatus 10. Upon connection of the hardware wallet A by the trading partner, the trading apparatus 10 generates an electronic signature A2 of the trading partner using an electronic signature value generated using information included in the transaction Tx2 and the secret key “a” stored in the hardware wallet A. The trading partner then disconnects the hardware wallet A from the trading apparatus 10 (S5). At S5, for example, the trading partner connects the hardware wallet A to the trading apparatus 10 after the transaction Tx2 is recorded on a Litecoin blockchain and a completion of sending is presumed.

The trading apparatus 10 creates a transaction Tx3 for receiving the Litecoins from the trading apparatus 20. The trading apparatus 10 transmits the transaction Tx3 to the network 40 (S6). Accordingly, the transaction Tx3 is published on the network 40.

The input of the transaction Tx3 includes ScriptSigA2 (SSigA2) including the secret value R, the public key of the trading partner, and the electronic signature A2, and the transaction ID for identifying the transaction Tx2. The output of the transaction Tx3 includes ScriptPubKeyA2 (SPubKeyA2) including the public key hash of the trading partner. Therefore, at S6, the secret value R is published on the network 40 through transmission of the transaction Tx3 to the network 40.

The node device 400 connects the input of the transaction Tx3 and the output of the transaction Tx2 to each other and approves the transactions. Accordingly, the transaction Tx3 is recorded on the Litecoin blockchain and the process of sending Litecoins from the user to the trading partner is completed.

A specified time of the timelock included in the transaction Tx2 is set to be sufficiently longer than a time required to record the transaction Tx3 on the Litecoin blockchain. That is, the specified time is set to enable the processes at S5 and S6 to be preferentially performed over the returning process using the timelock. Accordingly, the user having received the Bitcoins from the trading partner is prevented from performing the process of returning Litecoins to his own address before the trading partner receives the Litecoins, so that the security in trading is ensured.

When the transaction Tx3 is published on the network 40 and the hardware wallet B is connected by the user, the trading apparatus 20 creates an electronic signature B2 of the user. The user then disconnects the hardware wallet B from the trading apparatus 20 (S7).

The trading apparatus 20 creates a transaction Tx4 for receiving the Bitcoins from the trading apparatus 10. The trading apparatus 20 then transmits the transaction Tx4 to the network 30 (S8).

The input of the transaction T4 includes ScriptSigB2 (SSigB2) including the secret value R published on the network 40 at S6, the public key of the user, and the electronic signature B2, and the transaction ID for identifying the transaction Tx1. The output of the transaction Tx4 includes ScriptPubKeyB2 (SPubKeyB2) including the public key hash of the user. The node device 300 then connects the input of the transaction Tx4 and the output of the transaction Tx1 to each other and approves the transactions. Accordingly, the transaction Tx4 is recorded on the Bitcoin blockchain and the process of sending the Bitcoins from the trading partner to the user is completed.

A specified time of the timelock included in the transaction Tx1 is set to be sufficiently longer than a time required to record the transaction Tx4 on the Bitcoin blockchain. That is, the specified time is set to enable the processes at S7 and S8 to be preferentially performed over the returning process using the timelock. Accordingly, the trading partner having received the Litecoins from the user is prevented from performing the process of returning Bitcoins to his own address before the user receives the Bitcoins, so that the security in trading is ensured.

In the processing of an atomic swap, generation of the transaction Tx3 and the transaction Tx4 is performed after the transaction Tx1 and the transaction Tx2 are recorded on the corresponding blockchains as described above.

The Bitcoin blockchain requires about 10 minutes to approve one block and link the block to the blockchain. A completion of sending is presumed when a block including the transaction Tx1 is recorded on the corresponding blockchain and then a plurality of blocks are linked after the block including the transaction Tx1. A sufficiently secure number that is considered to prevent falsification of a newly-linked block is defined as the number of the plurality of blocks.

Therefore, for example, when the number of the plurality of blocks is five, it takes at least about 60 minutes or a longer time before the transaction Tx1 is recorded in a block and the transaction Tx3 is created after the transaction Tx1 is created. In that case, when performing the atomic swap processing, the trading partner needs to perform an operation of attaching or detaching the hardware wallet A to or from the trading apparatus 10 at intervals of at least about 60 minutes or a longer time to keep the hardware wallet A in an offline state to the extent possible. When the sending fee of the transaction Tx1 is set low, the priority order of approval of the transaction by the node device 300 is also low and thus the time interval consequently becomes longer than 60 minutes in some cases.

The Litecoin blockchain requires about 2.5 minutes to approve one block and link the block to the blockchain. A completion of sending is presumed when a block including the transaction Tx2 is recorded on the corresponding blockchain and then a plurality of blocks are linked after the block including the transaction Tx2. A sufficiently secure number that is considered to prevent falsification of a newly-linked block is defined as the number of the plurality of blocks.

Therefore, for example, when the number of the plurality of blocks is five, it takes at least about 12.5 minutes or a longer time before the transaction Tx2 is recorded in a block and the transaction Tx4 is created after the transaction Tx2 is created. Accordingly, when performing the atomic swap processing, the user needs to perform an operation of attaching or detaching the hardware wallet B at intervals of at least about 12.5 minutes or a longer time to keep the hardware wallet B in an offline state to the extent possible. When the sending fee of the transaction Tx2 is set low, the priority order of approval of the transaction by the node device 400 is also low and the time interval consequently becomes longer than 12.5 minutes in some cases.

As described above, in an atomic swap using a hardware wallet, an operation of detaching a hardware wallet from a trading apparatus to be brought into an offline state is performed during a period other than the timing of executing the process of generating an electronic signature to ensure the security. Therefore, in the atomic swap using a hardware wallet, the operation of the user is complicated because the hardware wallet needs to be attached to or detached from a trading apparatus to ensure the security.

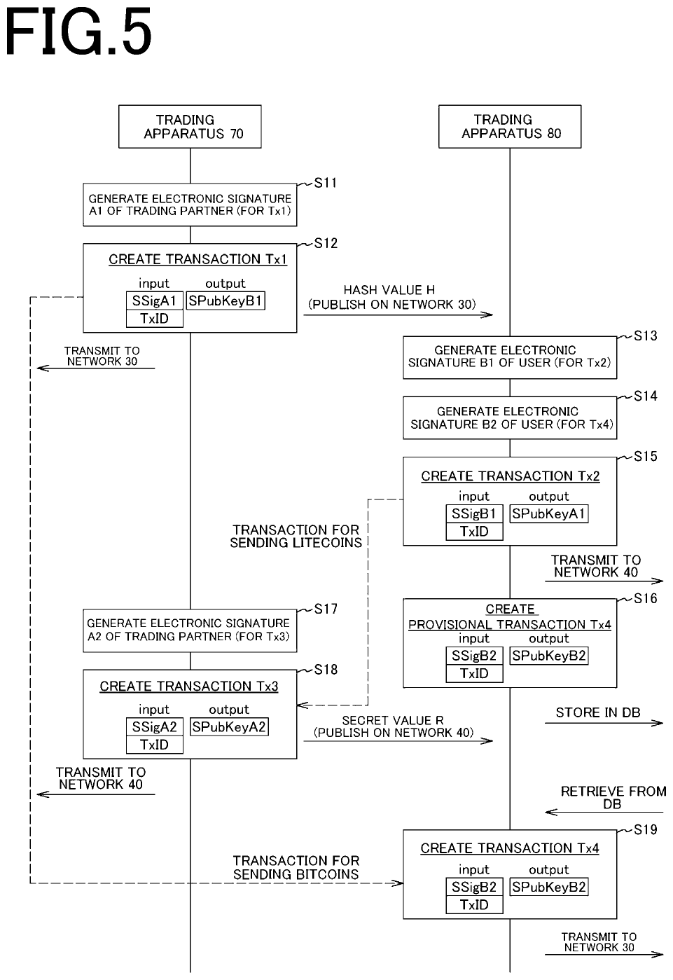

FIG. 5 is a sequence diagram illustrating an example of the processing of an atomic swap using a hardware wallet according to the embodiment. An example of the processing of an atomic swap using a hardware wallet is explained with reference to FIG. 5. A network used in an atomic swap includes a trading apparatus 70, a trading apparatus 80, the network 30, the network 40, and the network 200 as illustrated in FIG. 1. The trading apparatus 70, the trading apparatus 80, the network 30, and the network 40 are connected to be communicable with each other via the network 200.

Explanations of the processes explained with reference to FIGS. 3 and 4 are omitted. In the following explanations, descriptions of data included in electronic signatures and transactions in the embodiment described in FIG. 5 are same as those of the data included in the electronic signatures and the transactions explained with reference to FIG. 4, and thus these elements are denoted by like reference signs and explanations thereof are omitted. Processes performed by the trading apparatus 70 explained below may be performed by the trading apparatus 80, and processes performed by the trading apparatus 80 may be performed by the trading apparatus 70.

The trading apparatus 70 and the trading apparatus 80 are, for example, computer devices which will be described later. In the following explanations, it is assumed as an example that the trading apparatus 70 is a trading apparatus operated by a trading partner. It is also assumed that the trading apparatus 80 is a trading apparatus operated by a user.

When the hardware wallet A is connected by the trading partner, the trading apparatus 70 generates the electronic signature A1 using the secret key “a” of the trading partner. Upon generation of the electronic signature A1 using the secret key “a”, the trading partner disconnects the hardware wallet A from the trading apparatus 70 (311). The trading apparatus 70 randomly generates the secret value R. Further, the trading apparatus 70 applies a hash function to the secret value R to generate the hash value H. The hash function used by the trading apparatus 70 to hash the secret value R is, for example, a one-way hash function such as SHA-2, MD5, or SHA-1.

The trading apparatus 70 creates transaction Tx1 for sending Bitcoins to the user. The trading apparatus 70 transmits the transaction Tx1 to the network 30 (312). Accordingly, the transaction Tx1 is published on the network 30. Therefore, the hash value H included in ScriptPubKeyB1 (SPubKeyB1) of the transaction Tx1 is also published on the network 30.

When the hardware wallet B is connected by the user after the transaction Tx1 is published on the network 30, the trading apparatus 80 creates the electronic signature B1 using the secret key b of the user (313). The trading apparatus 80 also generates the electronic signature B2 of the user. Upon generation of the electronic signature B1 and the electronic signature B2 using the secret key b, the user disconnects the hardware wallet B from the trading apparatus 80 (S14).

For example, the trading apparatus 80 monitors whether the transaction Tx1 has been published on the network 30 by a method described below and performs the processes at S13 and S14 upon determination that the transaction Tx1 has been published on the network 30.

The trading apparatus 80 can determine whether transaction Tx1 has been published on the network 30, for example, by monitoring transactions transmitted from the trading apparatus 70 using the address of the trading partner. The trading apparatus 80 may alternatively determine that the transaction Tx1 has been published on the network 30 by receiving the transaction ID of the transaction Tx1 from the trading apparatus 70 to monitor the Bitcoin blockchain.

When the transaction Tx1 has been published on the network 30, the trading apparatus 80 may notify the user of that fact using at least one of functions of the trading apparatus 80, such as audio, display, and vibration. When the transaction Tx1 has been published on the network 30, the trading apparatus 80 may alternatively output information to a mobile terminal carried by the user to notify the user of the fact using a function of the mobile terminal, such as audio, display, or vibration. In the explanations with reference to FIG. 5, it is assumed that the timing of the notification by the trading apparatus 80 is when the transaction Tx1 has been published on the network 30. The timing of the notification by the trading apparatus 80 is not limited thereto and may be other timings as long as the timing is after the transaction Tx1 is published on the network 30.

The trading apparatus 80 creates a transaction Tx2 for sending Litecoins to the trading apparatus 70 using the hash value H included in ScriptPubKeyB1 of the transaction Tx1 published at S12. The trading apparatus 80 transmits the transaction Tx2 to the network 40 after the transaction Tx1 is recorded on the Bitcoin blockchain (315). Accordingly, the transaction Tx2 is published on the network 40.

The trading apparatus 80 creates a provisional transaction Tx4 for receiving the Bitcoins from the trading apparatus 70 using the information included in the transaction Tx1 published at 312. The trading apparatus 80 stores therein the provisional transaction Tx4 (316). The provisional transaction Tx4 is information of the transaction Tx4 except the secret value R. That is, the provisional transaction Tx4 is a transaction Tx4 not including the secret value R, which is created using information obtained before the secret value R is published on the network 40. The processes from S13 to S16 may be performed in any order as long as the order of the processes where the process at S15 is performed after the process at S13 and the process at S16 is performed after the process at S14 is maintained.

When the hardware wallet A is connected by the trading partner after the transaction Tx2 is published on the network 40, the trading apparatus 70 generates an electronic signature value using the information described in the transaction Tx2. The trading apparatus 70 generates the electronic signature A2 of the user using the electronic signature value and the secret key “a” stored in the hardware wallet A. Upon generation of the electronic signature A2 using the secret key “a”, the trading partner disconnects the hardware wallet A from the trading apparatus 70 (S17).

For example, the trading apparatus 70 monitors whether the transaction Tx2 has been published on the network 40 by a method described below and performs the process at S17 upon determination that the transaction Tx2 has been published on the network 40.

The trading apparatus 70 can determine whether the transaction Tx2 has been published on the network 40, for example, by monitoring transactions transmitted from the trading apparatus 80 using the address of the user. The trading apparatus 70 may alternatively determine that the transaction Tx2 has been published on the network 40 by receiving the transaction ID of the transaction Tx2 from the trading apparatus 80 to monitor the Litecoin blockchain.

When the transaction Tx2 has been published on the network 40, the trading apparatus 70 may notify the trading partner of the fact using at least one of functions of the trading apparatus 70, such as audio, display, and vibration. When the transaction Tx2 has been published on the network 40, the trading apparatus 70 may alternatively output information to a mobile terminal carried by the trading partner to notify the trading partner of the fact using a function of the mobile terminal, such as audio, display, or vibration. In the explanations with reference to FIG. 5, it is assumed that the timing of the notification by the trading apparatus 70 is when the transaction Tx2 has been published on the network 40. The timing of the notification by the trading apparatus 70 is not limited thereto and may be other timings as long as the timing is after the transaction Tx2 is published on the network 40.

Upon generation of the electronic signature A2, the trading apparatus 70 creates a transaction Tx3 including the electronic signature A2 for receiving the Litecoins from the trading apparatus 80. The trading apparatus 70 transmits the transaction Tx3 to the network 40 after the transaction Tx2 is recorded on the Litecoin blockchain (S18). Accordingly, the transaction Tx3 is published on the network 40. Therefore, the secret value R included in ScriptSigA2 (SSigA2) of the transaction Tx3 is also published on the network 40. By being approved by the node device 400, the transaction Tx3 is recoded on the Litecoin blockchain. The processes at S14, S16, S17, and S18 may be performed in any order as long as the order of the processes where the process at S16 is performed after the process at S14, the process at 317 is performed after the process at 516, and the process at 318 is performed after the process at S17 is maintained.

The trading apparatus 80 creates a transaction Tx4 for receiving the Bitcoins from the trading apparatus 70 using the secret value R included in ScriptSigA2 of the transaction Tx3 published at S18 and the stored provisional transaction Tx4. The trading apparatus 80 transmits the transaction Tx4 to the network 30 (319). Accordingly, the transaction Tx4 is published on the network 30. The transaction Tx4 is approved by the node device 300, thereby being recorded on the Bitcoin blockchain.

While the trading apparatus 80 creates the provisional transaction Tx4 at S16 in the above explanations, the trading apparatus 80 may store therein the electronic signature B2 at S14 to omit the process at S16. In this case, the trading apparatus 80 stores therein the electronic signature B2 generated at S14 and creates the transaction Tx4 at S19 using the secret value R included in ScriptSigA2 of the transaction Tx3 published on the network 40 and the stored electronic signature B2.

When a node device acquires the secret value R and the hash value H from a transaction and performs a verification to determine whether the hash value obtained by applying a hash function to the secret value R matches the hash value H, instead of the fourth verification described above, a configuration described below may be employed. While it is assumed that the hash value H is included in ScriptPubKeyA1 and ScriptPubKeyB1 in the above explanations, the hash value H may be included as a numerical value in the transaction Tx1 and the transaction Tx2. While the secret value R has been explained as being included in ScriptSigA2 and ScriptSigB2, the secret value R may be included as a numerical value in the transaction Tx3 and the transaction Tx4.

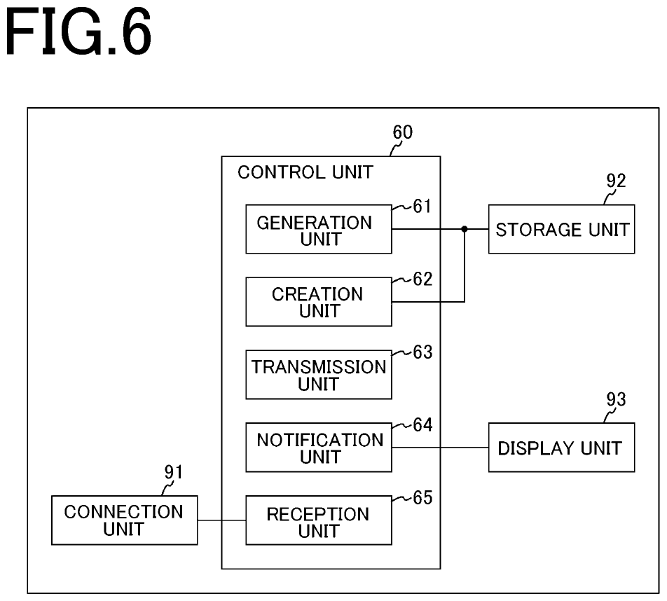

FIG. 6 is a functional block diagram illustrating a practical example of the trading apparatus. FIG. 6 is a block diagram illustrating functions included in the trading apparatus 70 and the trading apparatus 80. The functions of the trading apparatus 80 are explained with reference to FIG. 6. The trading apparatus 70 can have at least one or more of the functions of the trading apparatus 80. In the following explanations, the constituent elements explained with reference to FIG. 5 are denoted by like reference signs and explanations thereof are omitted. A process of delivering Bitcoins and a process of receiving the Bitcoins are a process of transferring ownership of the Bitcoins. A process of delivering Litecoins and a process of receiving the Litecoins are a process of transferring ownership of the Litecoins, Bitcoins are an example of first data. Litecoins are an example of second data.

The transfer device 80 includes a control unit 60, a connection unit 91, a storage unit 92, and a display unit 93. The control unit 60 includes a generation unit 61, a creation unit 62, a transmission unit 63, a notification unit 64, and a reception unit 65. The connection unit 91 is detachably connected to the hardware wallet B (a storage device) that has stored therein the secret key b to be used to generate the electronic signature B1 and the electronic signature B2. The storage unit 92 stores therein various types of information. The display unit 93 displays various types of information.

The storage unit 92 stores therein at least either the electronic signature B2 generated by the generation unit 61 or the provisional transaction Tx4 created by the creation unit 62. The storage unit 92 may store therein the transaction Tx2 created by the creation unit 62. The storage unit 92 may further store therein the electronic signature B1. The transaction Tx2 is information used for a trade in which Litecoins are delivered from the user to the trading partner. The transaction Tx2 is an example of second trading information. The transaction Tx4 is information used for a trade in which the user receives Bitcoins from the trading partner. The transaction Tx4 is an example of fourth trading information.

The generation unit 61 generates the electronic signature B1 to be included in the transaction Tx2 including the hash value H calculated using the secret value R after the transaction Tx1 including the hash value H is published on the network 30. That is, the generation unit 61 generates the transaction Tx2 including the hash value H using the hash value H included in the transaction Tx1. At this time, the generation unit 61 generates the electronic signature B1 using the secret key b stored in the hardware wallet B connected by the user to the connection unit 91. The secret value R is an example of secret information. The hash value H is an example of specific information. The transaction Tx1 is information used for a trade in which Bitcoins are delivered from the trading partner to the user. The Transaction Tx1 is an example of first trading information. The electronic signature B1 is an example of a first electronic signature. The network 30 is an example of a first network.

The generation unit 61 generates the electronic signature B2 to be included in the transaction Tx4 using information included in the transaction Tx1 after the transaction Tx1 is published on the network 30. At this time, the generation unit 61 generates the electronic signature B2 using the secret key b stored in the hardware wallet B connected by the user to the connection unit 91. The generation unit 61 may store the generated electronic signature B2 in the storage unit 92. The electronic signature B2 is an example of a second electronic signature. The information included in the transaction Tx1 is, for example, ScriptPubKeyB1 of the transaction Tx1, which is connected to ScriptSigB2 of the transaction Tx4.

The creation unit 62 creates the transaction Tx2 including the hash value H and the electronic signature B1. The creation unit 62 may store the created transaction Tx2 in the storage unit 92. When the electronic signature B2 is stored in the storage unit 92, the creation unit 62 creates the transaction Tx4 including the secret value R and the electronic signature B2 using the electronic signature B2 stored in the storage unit 92 after the transaction Tx3 including the secret value R is published on the network 40. The creation unit 62 may delete the electronic signature B2 from the storage unit 92 to ensure the security after the transaction Tx4 is created. The transaction Tx3 is a transaction used for a trade in which the trading partner receives the Litecoins from the user. The transaction Tx3 is an example of third trading information. The network 40 is an example of a second network.

The creation unit 62 may create the provisional transaction Tx4 and store the provisional transaction Tx4 in the storage unit 92. That is, the creation unit 62 stores the electronic signature B2 in the storage unit 92 in a state where the electronic signature B2 is included in the provisional transaction Tx4. When the provisional transaction Tx4 is stored in the storage unit 92, the creation unit 62 creates the transaction Tx4 using the provisional transaction Tx4 stored in the storage unit 92 after the transaction Tx3 including the secret value R is published on the network 40. The creation unit 62 may delete the electronic signature B2 from the storage unit 92 to ensure the security after the transaction Tx4 is created. Alternatively, the creation unit 62 may create the transaction Tx4 using either the electronic signature B2 or the provisional transaction Tx4 when the electronic signature B2 and the provisional transaction Tx4 are stored in the storage unit 92.

When the electronic signature B1 is stored in the storage unit 92, the creation unit 62 may create the transaction Tx2 including the hash value H and the electronic signature B1 using the electronic signature B1 stored in the storage unit 92 after the transaction Tx1 is published on the network 30. In this case, the creation unit 62 may create the transaction Tx2 including the hash value H and the electronic signature B1 using the electronic signature B1 stored in the storage unit 92 after the transaction Tx1 is recorded on the Bitcoin blockchain.

The transmission unit 63 transmits the transaction Tx4 to the network 30. The transmission unit 63 also transmits the transaction Tx2 to the network 40. That is, the transmission unit 63 transmits the transaction Tx4 to the network 30 on which the trade of Bitcoins is performed. The transmission unit 63 also transmits the transaction Tx2 to the network 40 on which the trade of Litecoins is performed.

The transmission unit 63 determines whether the transaction Tx1 has been recorded on the Bitcoin blockchain when the storage unit 92 has the transaction Tx2 stored therein. The transmission unit 63 transmits the transaction Tx2 stored in the storage unit 92 to the network 40 after the transaction Tx1 is recorded on the Bitcoin blockchain.

After the transaction Tx1 is published on the network 30, the notification unit 64 notifies of publication of the transaction Tx1. The notification unit 64 can determine whether the transaction Tx1 has been published, for example, by monitoring transactions transmitted to the address of the user on the network 30. When the transaction Tx1 has been published, the notification unit 64 may, for example, notify the user of publication of the transaction Tx1 by displaying information indicating publication of the transaction Tx1 on the display unit 93.

The notification unit 64 can notify that the transaction Tx1 has been recorded on the Bitcoin blockchain after the transaction Tx1 is recorded on the Bitcoin blockchain. The notification unit 64 can determine whether the transaction Tx1 has been recorded on the Bitcoin blockchain, for example, by monitoring transactions transmitted to the address of the trading partner on the network 40. Alternatively, the notification unit 64 may, for example, display information indicating that the transaction Tx1 has been recorded on the display unit 93 after the transaction Tx1 is recorded on the Bitcoin blockchain. Accordingly, the notification unit 64 may notify the trading partner that the transaction Tx1 has been recorded on the Bitcoin blockchain.

The reception unit 65 receives an input of the secret key b by the user when the hardware wallet B is connected to the connection unit 91. For example, the reception unit 65 may automatically acquire the secret key b when the hardware wallet B is connected to the connection unit 91.

The functions of the trading apparatus 70 are explained with reference to FIG. 6. The trading apparatus 80 can have at least one or more functions of the trading apparatus 70. The transfer device 70 includes the control unit 60, the connection unit 91, the storage unit 92, and the display unit 93. The control unit 60 includes the generation unit 61, the creation unit 62, the transmission unit 63, the notification unit 64, and the reception unit 65. The connection unit 91 is detachably connected to the hardware wallet A (a storage device) that has stored therein the secret key “a” to be used to generate the electronic signature A1 and the electronic signature A2. The storage unit 92 stores therein various types of information. The display unit 93 displays various types of information.

The generation unit 61 generates the electronic signature A1 using the secret key “a” stored in the hardware wallet A connected by the user to the connection unit 91. The generation unit 61 also generates the electronic signature A2 using the secret key “a” stored in the hardware wallet A connected by the user to the connection unit 91 and information included in the transaction Tx2 after the transaction Tx2 is published on the network 40.

The creation unit 62 creates the transaction Tx1 using the hash value H and the electronic signature A1, The creation unit 62 also creates the transaction Tx3 using the secret value R and the electronic signature A2.

The transmission unit 63 transmits the transaction Tx1 to the network 30. The transmission unit 63 also transmits the transaction Tx3 to the network 40. That is, the transmission unit 63 transmits the transaction Tx1 to the network 30 in which a trade of Bitcoins is performed. The transmission unit 63 further transmits the transaction Tx3 to the network 40 in which a trade of Litecoins is performed.

The notification unit 64 notifies of publication of the transaction Tx2 when the transaction Tx2 has been published on the network 40. For example, the notification unit 64 can determine whether the transaction Tx2 has been published by monitoring transactions transmitted to the address of the trading partner on the network 40. The notification unit 64 may notify the trading partner of publication of the transaction Tx2, for example, by displaying information indicating that the transaction Tx2 has been published on the display unit 93 when the transaction Tx2 has been published.

The notification unit 64 may notify that the transaction Tx2 has been recorded on the Litecoin blockchain after the transaction Tx2 is recorded on the Litecoin blockchain. The notification unit 64 can, for example, determine whether the transaction Tx2 has been recorded on the Litecoin blockchain by monitoring transactions transmitted to the address of the trading partner on the network 40, The notification unit 64 may, for example, display information indicating that the transaction Tx2 has been recorded on the display unit 93 after the transaction Tx2 is recorded on the Litecoin blockchain. In this way, the notification unit 64 can notify the trading partner that the transaction Tx2 has been recorded on the Litecoin blockchain.

The reception unit 65 receives an input of the secret key “a” by the user when the hardware wallet A is connected to the connection unit 91, The reception unit 65 may, for example, automatically acquire the secret key “a” when the hardware wallet A is connected to the connection unit 91.

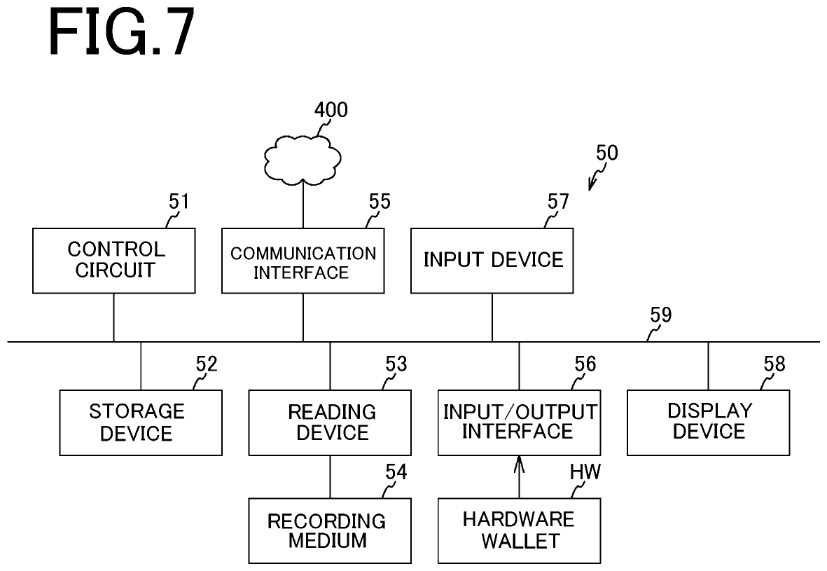

FIG. 7 is a block diagram illustrating a practical example of the computer device. A configuration of a computer device 50 is explained with reference to FIG. 7. In FIG. 7, the computer device 50 includes a control circuit 51, a storage device 52, a reading device 53, a recording medium 54, a communication interface 55, an input/output interface 56, an input device 57, and a display device 58. The communication interface 55 is connected to the network 400. These constituent elements are connected with a bus 59. The trading apparatus 10, the trading apparatus 20, the trading apparatus 70, and the trading apparatus 80 can be configured by appropriately selecting some or all of the constituent elements of the computer device 50.

The control circuit 51 controls the entire computer device 50. The control circuit 51 is, for example, a processor such as a central processing unit (CPU). For example, in FIG. 6, the control circuit 51 functions as the control unit 60.

The storage device 52 stores various types of data therein. The storage device 52 is, for example, a memory such as a read only memory (ROM) or a random access memory (RAM), or a hard disk (HD). The storage device 52 can have stored therein a trading program for causing the control circuit 51 to function as the control unit 60. For example, the storage device 52 functions as the storage unit 92 in FIG. 6.

The trading apparatus 70 and the trading apparatus 80 load the trading program stored in the storage device 52 into the RAM when performing a trading process, The trading program loaded into the RAM is executed by the control circuit 51, so that the trading apparatus 70 and the trading apparatus 80 execute a trading process including any one or more of a generation process, a creation process, a transmission process, a notification process, a connection process, and a reception process. The trading program may be stored in a storage device included in a server on the network 400 as long as the control circuit 51 can access the trading program via the communication interface 55.

The reading device 53 is controlled by the control circuit 51 and performs read/write of data from/in the detachable recording medium 54.

The recording medium 54 stores various types of data therein. The recording medium 54 stores, for example, a trading process program therein. The recording medium 54 is, for example, a non-transitory computer-readable recording medium such as a secure digital (SD) memory card, a floppy disk (FD), a compact disc (CD), a digital versatile disk (DVD), a Blu-ray (registered trademark) disk (BD), and a flash memory.

The communication interface 55 connects the computer device 50 to other devices via the network 400 to be communicable with each other.

The input/output interface 56 is, for example, an interface that detachably connects to various input devices. The input devices connected to the input/output interface 56 include, for example, a hardware wallet HW, a keyboard, and a mouse. The input/output interface 56 connects the computer device 50 to the connected input devices to be communicable with each other. The input/output interface 56 outputs a signal input from the connected input devices to the control circuit 51 via the bus 59. The input/output interface 56 outputs a signal output from the control circuit 51 to the connected input devices via the bus 59. The hardware wallet HW is, for example, the hardware wallet A and the hardware wallet B. For example, the input/output interface 56 functions as the connection unit 91 in FIG. 6.

The input device 57 is, for example, a touch panel, a code reading device, or a keyboard. The various input devices connected to the input/output interface 56 and the input device 57 may receive, for example, inputs of a secret key, a public key, a transaction ID, and the secret value R from the user and the trading partner.

The display device 58 displays various types of information. For example, the display device 58 can display an image indicating publication of the transaction Tx1 when the transaction Tx1 has been published. The display device 58 can also display, for example, an image indicating publication of the transaction Tx2 when the transaction Tx2 has been published. The display device 58 may also display information for receiving an input on a touch panel. For example, the display device 58 functions as the display unit 93 in FIG. 6.

The network 400 is, for example, a LAN, a wireless communication, a P2P network, or the Internet and communicably connects the computer device 50 to other devices.

As described above, the trading apparatus 80 of the embodiment generates the electronic signature B1 and the electronic signature B2 after the transaction Tx1 is published on the network 30, and stores the electronic signature B2 in the storage device 52. The trading apparatus 80 then creates the transaction Tx4 using the secret value R included in the transaction Tx3 and the electronic signature B2 stored in the storage device 52 after the transaction Tx3 is published on the network 40. Therefore, the trading apparatus 70 can perform the processing of an atomic swap only with one time connection of a hardware wallet and thus the operation of the user can be simplified.

The trading apparatus 80 of the embodiment generates the electronic signature B1 and the electronic signature B2 after the transaction Tx1 is published on the network 30. The trading apparatus 80 further creates the provisional transaction Tx4 not including the secret value R and stores the provisional transaction Tx4 in the storage device 52. The trading apparatus 80 creates the transaction Tx4 using the secret value R included in the transaction Tx3 and the provisional transaction Tx4 stored in the storage device 52 after the transaction Tx3 is published on the network 40. Since this enables the trading apparatus 80 to perform the processing of an atomic swap only with one time connection of a hardware wallet, the operation of the user can be simplified.

The trading apparatus 80 of the embodiment notifies the user of publication of the transaction Tx1 after the transaction Tx1 is published on the network 30 by the trading apparatus 70. Accordingly, the trading apparatus 80 can inform the user of a timing to connect the hardware wallet B after the transaction Tx1 is published. The trading apparatus 80 may notify the user that the transaction Tx1 has been recorded on the Bitcoin blockchain after the transaction Tx1 is recorded on the Bitcoin blockchain. Accordingly, the trading apparatus 80 can inform the user of a timing to connect the hardware wallet B after the transaction Tx1 is recorded on the Bitcoin blockchain. In this case, the trading apparatus 80 can shorten the time in which the storage unit 92 has the electronic signature B1 and the electronic signature B2 stored therein as compared to a case where the hardware wallet B is connected to the connection unit 91 before the transaction Tx1 is recorded on the Bitcoin blockchain. Therefore, the trading apparatus 80 can perform a more secure trade.

The trading apparatus 80 of the embodiment has the connection unit 91 that is detachably connected to the hardware wallet B and therefore can bring the hardware wallet B to be offline during a period other than the time of executing the generation process of the electronic signature B1 and the electronic signature B2. Therefore, the trading apparatus 80 can enhance the security at the time of performing an atomic swap.

The trading apparatus 80 of the embodiment stores the electronic signature B1 and the electronic signature B2 in the storage device 52. The trading apparatus 80 then creates the transaction Tx2 including the hash value H and the electronic signature B1 using the electronic signature B1 stored in the storage device 52 after the transaction Tx1 is published on the network 30 by the trading apparatus 70. In this case, the trading apparatus 80 may create the transaction Tx2 including the hash value H and the electronic signature B1 using the electronic signature B1 stored in the storage unit 92 after the transaction Tx1 is recorded on the Bitcoin blockchain. This enables the trading apparatus 80 to receive connection of the hardware wallet B at a timing freely selected by the user and generate the electronic signature B1 and the electronic signature B2 at the same timing after the transaction Tx1 is published on the network 30. Therefore, the trading apparatus 80 can simplify the operation of the user.

The trading apparatus 80 of the embodiment stores the transaction Tx2 in the storage device 52. The trading apparatus 80 then transmits the transaction Tx2 stored in the storage device 52 to the network 40 after the transaction Tx1 is recorded on the Bitcoin blockchain. Accordingly, the trading apparatus 80 can reduce risks of duplicate payment.

While a Bitcoin blockchain and a Litecoin blockchain have been exemplified in the above explanations, other types of blockchains such as a Monacoin blockchain and an Ethereum blockchain can be alternatively used. Also in the case of using other blockchains, the trading apparatus 80 generates the electronic signature B1 and the electronic signature B2 at the same timing and stores the electronic signature B2 in the storage device 52, so that an atomic swap can be performed only with one time connection of the hardware wallet B.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A trading apparatus comprising:
a storage unit; and
a processor which executes a process, wherein the process includes:
generating a first electronic signature to be included in second trading information that is used for a trade in which second data is delivered from a user to a trading partner and that includes specific information calculated using secret information, after first trading information that is used for a trade in which first data is delivered from the trading partner to the user and that includes the specific information is published on a first network, and generating a second electronic signature to be included in fourth trading information that is used for a trade in which the user receives the first data from the trading partner using information included in the first trading information;
storing the second electronic signature in the storage unit;
creating the second trading information including the specific information and the first electronic signature, and creating the fourth trading information including the secret information and the second electronic signature using the second electronic signature stored in the storage unit after third trading information that is used for a trade in which the trading partner receives the second data from the user and that includes the secret information is published on a second network; and
transmitting the fourth trading information to the first network and transmitting the second trading information to the second network.

2. The trading apparatus according to claim 1, wherein the creating performed by the processor further includes creating the fourth trading information including the second electronic signature to store the fourth trading information in the storage unit, and creating the fourth trading information including the secret information and the second electronic signature using the fourth trading information including the second electronic signature stored in the storage unit after the third trading information including the secret information is published on the second network.

3. The trading apparatus according to claim 1, wherein the process executed by the processor further includes notifying publication of the first trading information after the first trading information is published on the first network.

4. The trading apparatus according to claim 1, further comprising a connection unit that is detachably connected to a storage device that has stored therein a secret key to be used to generate the first electronic signature and the second electronic signature, wherein the process executed by the processor further includes
receiving an input of the secret key when the storage device is connected to the connection unit.

5. The trading apparatus according to claim 1, wherein
the storage unit further stores therein the first electronic signature, and
the creating performed by the processor further includes creating the second trading information including the specific information and the first electronic signature using the first electronic signature stored in the storage unit after the first trading information is published on the first network.

6. The trading apparatus according to claim 1, wherein
the storage unit further stores therein the second trading information, and
the transmitting performed by the processor includes transmitting the second trading information stored in the storage unit to the second network after the first trading information is recorded on a blockchain that records therein trades occurring in the first network.

7. A trading method executed by a processor of a trading apparatus including a storage unit, wherein the processor executes a process comprising:
generating a first electronic signature to be included in second trading information that is used for a trade in which second data is delivered from a user to a trading partner and that includes specific information calculated using secret information, after first trading information that is used for a trade in which first data is delivered from the trading partner to the user and that includes the specific information is published on a first network, and generating a second electronic signature to be included in fourth trading information that is used for a trade in which the user receives the first data from the trading partner using information included in the first trading information;
storing the second electronic signature in the storage unit;
creating the second trading information including the specific information and the first electronic signature, and creating the fourth trading information including the secret information and the second electronic signature using the second electronic signature stored in the storage unit after third trading information that is used for a trade in which the trading partner receives the second data from the user and that includes the secret information is published on a second network; and
transmitting the fourth trading information to the first network and transmitting the second trading information to the second network.

8. A non-transitory computer-readable recording medium having recorded therein a program for causing a processor of a trading apparatus including a storage unit to execute a trading process, wherein the process comprises:
generating a first electronic signature to be included in second trading information that is used for a trade in which second data is delivered from a user to a trading partner and that includes specific information calculated using secret information, after first trading information that is used for a trade in which first data is delivered from the trading partner to the user and that includes the specific information is published on a first network, and generating a second electronic signature to be included in fourth trading information that is used for a trade in which the user receives the first data from the trading partner using information included in the first trading information;
storing the second electronic signature in the storage unit;
creating the second trading information including the specific information and the first electronic signature, and creating the fourth trading information including the secret information and the second electronic signature using the second electronic signature stored in the storage unit after third trading information that is used for a trade in which the trading partner receives the second data from the user and that includes the secret information is published on a second network; and
transmitting the fourth trading information to the first network and transmitting the second trading information to the second network.
